(19) United States
(12) Patent Application Publication
(10) Pub. No.: US 2005/0244718 A1
(43) Pub. Date: Nov. 3, 2005

(54) Polymerizable, luminescent compounds and mixtures, luminescent polymer materials and their use

(76) Inventors: Eike Poetsch, Muehltal (DE); Thomas Jacob, Seoul (KR); Jose Serrano, Zaragoza (ES); Milagros Pinol, Huesca (ES); Raquel Gimenez, Zaragoza (ES); Joachim Stumpe, Nauen (DE); Thomas Fischer, Berlin (DE); Regina Rosenhauer, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/519,712

(22) PCT Filed: Jun. 18, 2003
(86) PCT No.: PCT/EP03/06448

§ 371 Date: Dec. 30, 2004

(30) Foreign Application Priority Data
Jul. 1, 2002 (EP) 02014067.9

(51) Int. Cl. H01M 6/14

(52) U.S. Cl. 429/303

(57) ABSTRACT

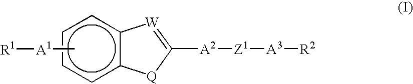

The invention relates to new polymerizable, luminescent compounds of formula I wherein R¹, R², A¹, A², A³, Z¹, W and Q have the meanings given in claim 1. Furthermore the invention relates to polymerizable mixtures containing compounds according to the invention and pleferably at least one polymerizable mesogenic compound. Polymer materials obtainable by polymerizing such mixtures are also described. These compounds, mixtures and materials show advantageous photoluminescent and/or electroluminescent properties and may be used in light emitting devices and optical- or electrooptical display elements.

### FIELD OF INVENTION

The invention relates to polymerizable, luminescent compounds, to polymerizable mixtures comprising such compounds and to luminescent polymer materials obtainable by polymerizing such compounds or mixtures. Furthermore the invention relates to the use of these compounds and mixtures for the manufacture of photoluminescent and/or electroluminescent polymer materials. The invention also relates to the use of these polymer materials as photo- and/or electroluminescent materials in light emitting devices, optical and/or electrooptical display elements. Additionally the invention relates to light emitting devices and optical or electrooptical display elements comprising these polymer materials.

### BACKGROUND AND PRIOR ART

Luminescent polymers showing photoluminescence as well as polymers showing electroluminescence were proposed to be used in light emitting devices and electrooptical display elements.

The organic light emitting devices or diodes (OLEDs) currently being under intense research consist of at least one emission layer. Common OLEDs are realized using multilayer structures, where an emission layer is sandwiched between one or more electron-transport and/or hole-transport layers. By applying an electric voltage electrons and holes as charge carriers move towards the emission layer where their recombination leads to the excitation and hence luminescence of the lumophor units contained in the emission layer. The sandwich structure is built by vacuum deposition or spin coating techniques which may include a polymerization step before applying the next layer (Meerholz et al., Synthetic Metals 111-112 (2000) 31-34). OLEDs which are available in different colors have the potential of being used as the building blocks of different kind of information displays.

Also anisotropic luminescent polymers are known where the polymer and/or lumophor units are oriented. These emissive materials show anisotropic absorption and/or anisotropic emission of polarized light. The degree of absorption and/or emission of linearly polarized light depends on the relative orientation of the wavevector to the main director of the fluorophor molecules. Such an orientation within the luminescent materials can be achieved by different methods:
incorporation of luminescent molecules into an oriented polymer prior or after the orientation step,
tensile orientation of a ductile luminescent polymer (e. g. the techniques described in WO 00/07525),
rubbing of the luminescent polymer,
applying the Langmuir-Blodgett technique,
oriented growth of the luminescent materials onto oriented substrates, like onto known alignment layers,
polymerization of oriented liquid crystals,
photo-induced alignment,
alignment in electric, magnetic or flow fields.

By using their anisotropic optical characteristics, these materials can replace polarizers and/or color filters which reduce the light efficiency in liquid crystal displays (LCDs) by up to 80% and more. Hence display devices employing such anisotropic luminescent polymers are described to show a high brigthness and contrast, and furthermore a good viewing angle (Weder et al., Science 279 (1998), 835 and EP 889 350 A1). Using pixel elements of at least three different photoluminescent materials multicolor images may be displayed. In major embodiments of such display devices an anisotropic photoluminescent layer substitutes the polarizer of a conventional backlight-polarizer-light valve-polarizer arrangement, where the light valve uses known electrooptical effects of liquid crystal materials, like the TN- or ECB-effect. A high degree of polarized emission is necessary in embodiments where the photoluminescent layer is arranged directly behind the backlight. Whereas a high degree of polarized absorption is mandatory in devices where the photoluminescent layer is placed behind the light valve.

In EP 889 350 A1 examples are described with alkoxy substituted poly(phenyleneethynylene)s (PPEs) in ultra high molecular weight polyethylene as photoluminescent polymers.

Another type of display uses polarized electroluminescence as background illumination of LCDs. Luessem et al. (Liquid Crystal 21 (1996), 903) report the fabrication of polymer based LEDs showing polarized electroluminescence. The orientation of the molecules within the light emitting layer was accomplished by the self organization of liquid crystal polymers (LCPs) deposited onto a rubbed polyimide film serving as an alignment layer. A main chain polymer of the following structure was used as LCP with a maximum of emission at 450 nm

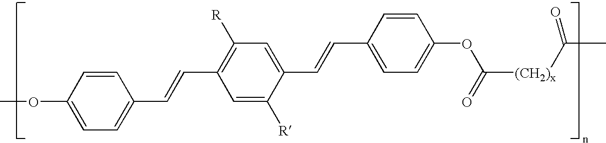

The photoluminescence stability of a cyanoterphenyl chromophor in a liquid crystalline polymeric system was studied by Alcala et al. (J. Appl. Phys. 88 (2000) 7124-7128 and 87 (2000) 274-279). It was found that the order parameter and consequently the dichroism of the luminescence is higher in polymers with a low crosslinking degree. The photoluminescent materials were prepared by photopolymerization of a monoacrylate (NAP), a diacrylate (C6M), a cyanoterphenyl chromophor with an acrylate group (CNT), a photoinitiator and a therrnal inhibitor. The orientation was achieved by introducing the monomer mixture into a planar cell with rubbed surfaces prior to polymerization. The monomers NAP and C6M consisted of rod-like liquid crystalline or mesogenic groups where at one or both ends the polymerizable acrylate group was bound via a hexylene spacer group. In the resulting polymer the rodlike cyanoterphenyl chromophor group holds the same orientation as the LC or mesogenic groups being connected to the acrylate-built main chains.

The synthesis of chiral 2-arylbenzoxazole derivatives of the following formula as monomers and of their resulting polymers was investigated by Park et al., Bull. Korean Chem. Soc. 20, 1999, 473, 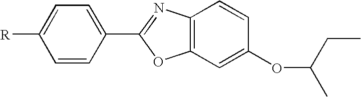
wherein R contains a spacer and a polymerizable acrylate-group. The compounds show fluorescent and liquid crystalline behaviour.

Chiral liquid crystalline polymer materials comprising at least one chemically bound chromophor group are a major component of pigment flakes disclosed in WO 98/42799. These pigment flakes are obtainable from a polymerizable mesogenic compound of the formula I*
P—(Sp—X)ₙ-CG-R I*
wherein
P is a polymerizable group,
Sp is a spacer group,
X denotes —O—, —S—, —CO—, —COO—, —OCO—, —O—COO—, —SO₂—O—, —O—SO₂— or a single bond,
R is H or an alkyl radical in which H-atoms and/or CH₂-groups may be substituted and
CG is a chromophoric or fluorescent chromophoric group.

Beside several other chromophoric groups 2,5-bis-(5′-tert.-butyl-2-benzoxazolyl)thiophene (BBOT) and benzoxazoles, like PBBO and POPOP, are disclosed.

One of the aims of the present invention is to provide polymerizable, luminescent compounds, which are especially suitable for the manufacture of luminescent polymer materials showing advantageous absorption and emission properties.

A further aim of this invention is to make available polymerizable, luminescent compounds, which are especially suitable for the production of anisotropic luminescent polymer materials showing advantageous anisotropic optical characteristics.

Another aim of the invention is to provide polymerizable mixtures for the production of luminescent and anisotropic luminescent polymer materials with the above mentioned characteristics.

Furthermore it is an aim of the present invention to make available luminescent as well as anisotropic luminescent polymer materials with the above mentioned characteristics.

Further aims of the invention are to extend the pool of polymerizable, luminescent compounds, of polymerizable mixtures comprising such compounds and of luminescent polymer materials available to the expert.

The aim of this invention is also to show advantageous uses of these polymerizable, luminescent compounds, mixtures and polymer materials.

Further aims of the invention relate to light emitting devices and optical or electrooptical display elements in which the polymer materials according to the invention are applied advantageously.

Other aims of the present invention are immediately evident to the person skilled in the art from the following detailed description.

### DEFINITION OF TERMS

The term luminescence means emission of electromagnetic radiation, preferably in, but not limited to, the visible spectrum, due to any kind of excitation, preferably by electromagnetic radiation (photoluminescence) or by an applied electric voltage (electroluminescence). The more general term luminescence encompasses phosphorescence and fluorescence, the lafter being the preferred meaning.

The terms polymerizable or reactive mesogen, polymerizable or reactive mesogenic compound, polymerizable or reactive liquid crystal and polymerizable or reactive liquid crystalline compound as used in the foregoing and the following comprise compounds with a rodlike, boardlike or disk-like mesogenic group. These mesogenic compounds do not necessarily have to exhibit mesophase behaviour by themselves. In a preferred embodiment of the present invention they show mesophase behaviour in mixtures with other compounds or after polymerization of the pure mesogenic compounds or of the mixtures comprising the mesogenic compounds.

### SUMMARY OF THE INVENTION

One of the objects of the present invention are polymerizable, luminescent compounds of formula I 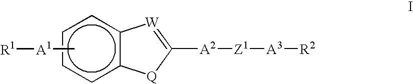
wherein
R¹, R² are independently of each other H, halogen, NO₂, CN, NCS, straight chain, branched or cyclic alkyl with 1 to 25 C-atoms wherein one or more CH₂ groups may also be replaced by —CO—, —O—, —S—, —NR⁰—, —CH=CH—, —C≡C— in such a manner that O- and/or S-atoms are not linked directly to one another, and wherein one or more H-atoms may also be replaced by F or Cl, or denotes P—(Sp—X)ₙ—,
Sp is a spacer group with 1 to 20 C-atoms,
P is a polymerizable group,
X is —O—, —S—, —CO—, —COO—, —OCO—, —CO—NR⁰—, —NR⁰—CO—, —NR⁰— or a single bond,
n is 0 or1,
R⁰ is H or alkyl with 1 to 5 C-atoms,
A¹ is 1,4-phenylene, wherein 1, 2, 3 or 4 H-atoms may be replaced by F or Cl, or a single bond, 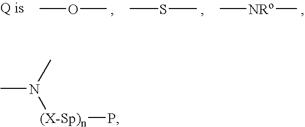
W is —CH═, —N═ or —CO—CH═,
A² is 1,4-phenylene or 2,5-thiophene, wherein in each case one or more H-atoms may be replaced by F or Cl, or denotes a single bond, 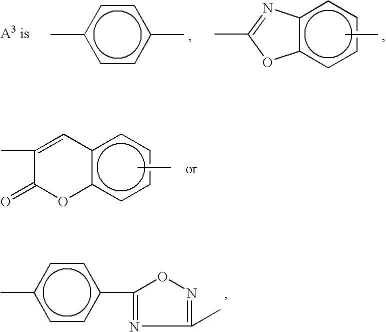
   wherein one or more H-atoms may be replaced by F or Cl,
Z¹ is —CH═CH—, —CF═CH—, —CH═CF—, —CF═CF— or a single bond with the proviso that
a) the compounds of formula I contain one, two or more groups —(X—Sp)ₙ—P,
b) if W denotes —CO—CH═, then 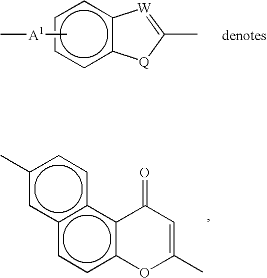
   [der Fall “not fused” ist wohl kein luminesz. Farbstoff]
c) if W is —N═, Q is —O—, A² and Z¹ are a single bond, A³ is 1,4-phenylene and R² is P—(Sp—X)ₙ- then R¹ is an achiral group, [siehe Kim et al., Bull Korean Chem. Soc. 20, 1999, 473]
d) if W is —N═, Q is —O—, A² and A³ denote 1,4-phenylene and Z¹ is a single bond then A¹ is a single bond.

Another object of the invention are polymerizable mixtures comprising at least one polymerizable, luminescent compound according to this invention.

A further object of this invention are luminescent polymer materials obtainable by polymerizing a polymerizable compound or mixture according to the invention.

Another object of the invention is the use of a polymerizable, luminescent compound or of a polymerizable mixture, both according to the invention, for the manufacture of photoluminescent and/or electroluminescent polymer materials.

An additional object of the invention is the use of a luminescent polymer material according to the invention as a photo- and/or electroluminescent material in a light emitting device, an optical or electrooptical display element.

Another object of the invention are light emitting devices comprising a polymer material according to the invention as a photo- and/or electroluminescent material.

A further object of the invention are optical or electrooptical display elements comprising a luminescent polymer material according to the invention as a photo- and/or electroluminescent material.

### DETAILED DESCRIPTION OF THE INVENTION

In the following the groups, substituents and indices R⁰, R¹, R², A¹, A², A³, Z¹, W, Q, Sp, P, X, n have the above given meaning unless stated otherwise.

The group 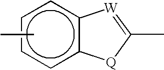
of the formula I has one of the meanings given by the subformulae

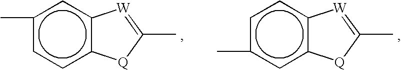

A preferred embodiment of the present invention relates to compounds of formula I wherein W denotes —N═.

Another preferred embodiment relates to compounds of formula I wherein W denotes —CH═ and Q is —O—.

Preferred compounds of formula I are those of the following subformulae 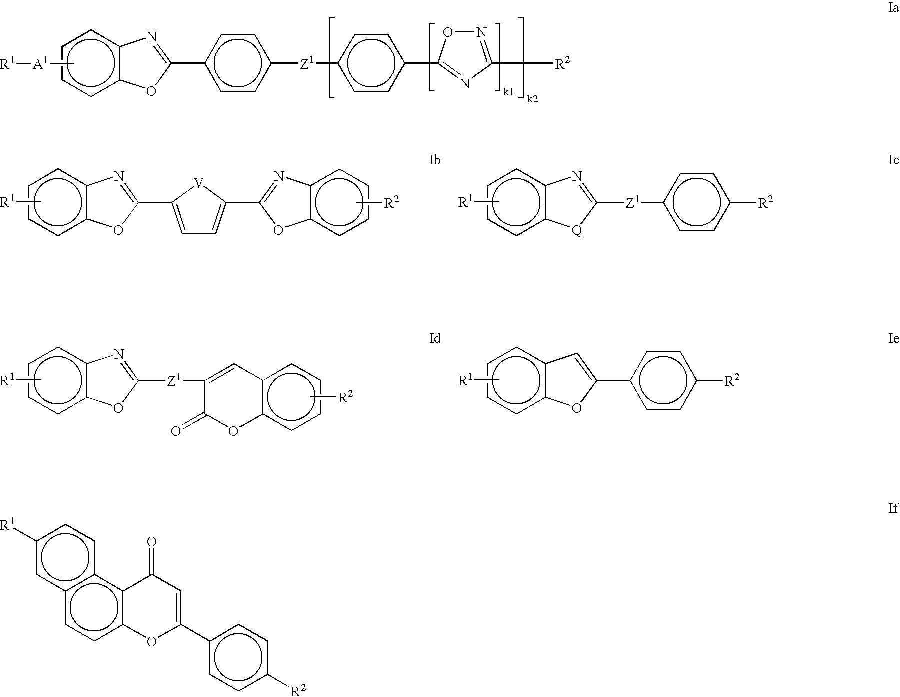
wherein
V denotes —CH═CH— or —S—,
k1 and k2 are independently of each other 0 or 1 and
with the proviso that if Z¹ denotes a single bond, k1=0 and k2 =1, then A¹ is a single bond.

The inventive polymerizable, luminescent compounds of formula I have the major advantage that they can be chemically bound to the polymer matrix. Unlike those luminescent compounds which are not polymerizable and therefore not chemically bound, no diffusion processes may alter their absorption and emission properties. Furthermore the orientation of the compounds according to the invention may be frozen by a polymerization and/or cross-linking step, leading to materials with anisotropic absorption and emission characteristics which are stable over time. Further advantages of the inventive compounds, especially those of formulae Ia to If, are:
they exhibit advantageous absorption and emission characteristics,
they show a high fluorescence quantum yield,
the luminescence of these compounds exhibits a small band width of the emission wavelength,
they show advantageous excitation wavelenghts, especially in the region 390 nm≦λ<450 nm,
they have a high stability under excitation with UV-light, especially at wavelengths λ≧390 nm,
they show a high ordering tendency in polymerizable mixtures according to the invention yielding a high orientation degree,
in an oriented state they show a high degree of optical anisotropy,
the starting materials can be obtained commercially or synthesized economically using methods known from the literature,
they exhibit a good solubility in polymerizable mixtures, especially in mixtures according to the invention.

Particularly preferred compounds of subformula Ia are those of the following subformulae 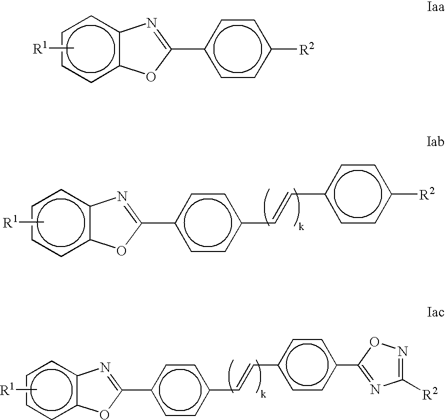
wherein k is 0 or 1.

Particularly preferred compounds of subformula Ib are those of the following subformulae

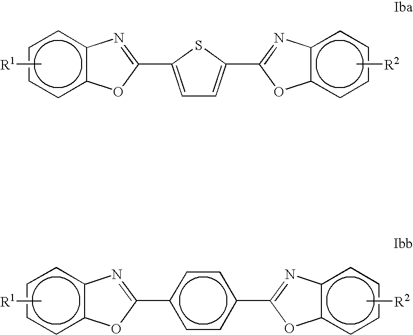

A particularly preferred compound of subformula Ic is that of the following subformula 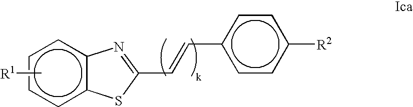
wherein k is 0 or 1.

Particularly preferred compounds of subformula Id are those of the following subformulae

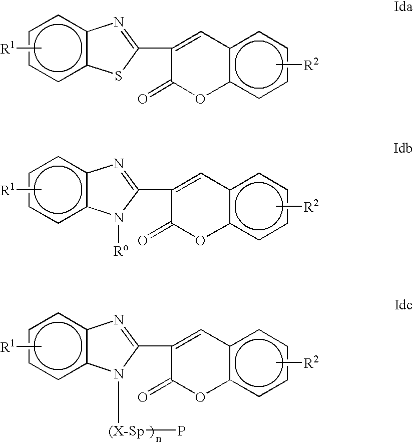

The following subformulae denote especially preferred compounds according to subformula Iaa

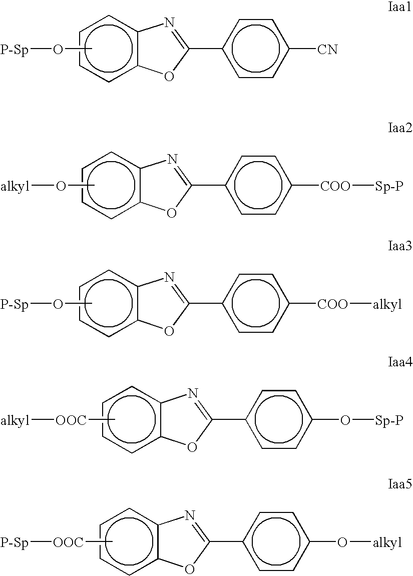

In the above and following formulae the term alkyl denotes a straight chain, branched or cyclic alkyl group with 1 to 12 C-atoms wherein one or more H-atoms can also be replaced by F or Cl.

Especially preferred compounds of subformula Iab are those of the following subformulae 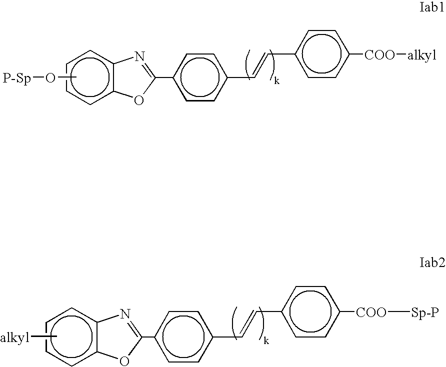
wherein k is 0 or 1.

Especially preferred compounds of subformula Iac are those of the following subformulae 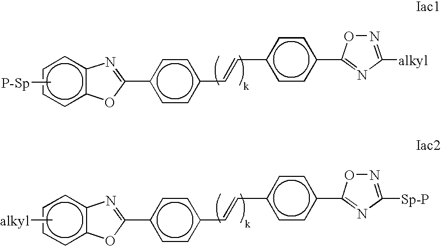
wherein k is 0 or 1.

Especially preferred compounds of the subformulae Iba and Ibb are those of the following subformulae

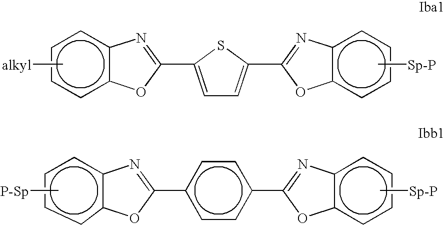

The following subformulae denote especially preferred compounds according to subformula Ica 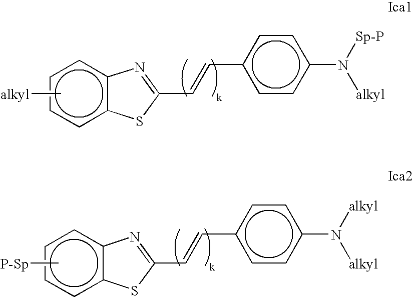
wherein k is 0 or 1.

Especially preferred compounds of the subformulae Ida, Idb and Idc are those of the following subformulae

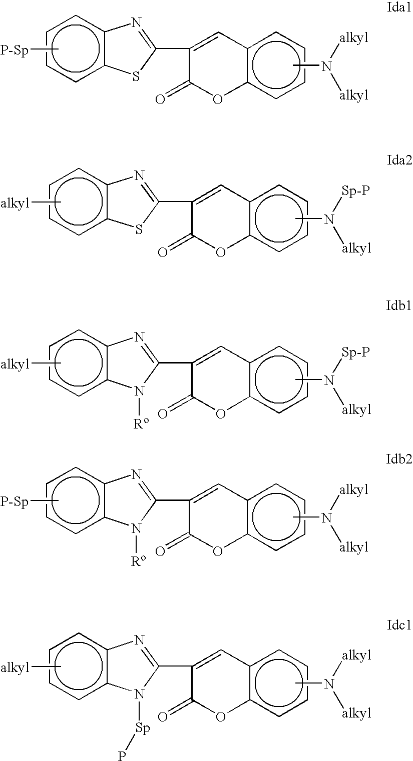

An especially preferred compound of subformula Ie is one of the subformula Ie1

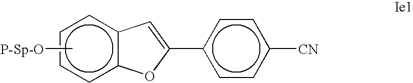

The following subformulae denote especially preferred compounds according to subformula If

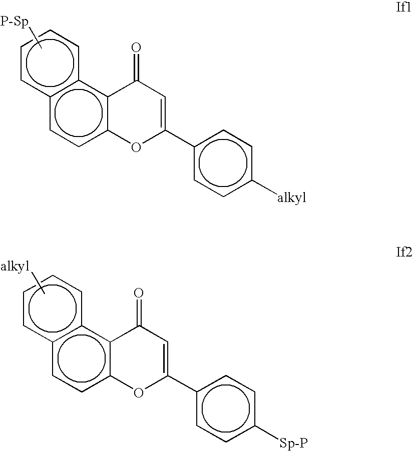

The above mentioned compounds of formula I may contain one (monofunctional) or two or more (multifunctional) polymerizable groups —(X—Sp)ₙ—P. One or two polymerizable groups are preferred.

Preferred compounds with two polymerizable groups are of the formulae Iaa1 to Iaa5, Iab₁, Iab2, Iac₁, Iac2, Iba1, Ibb1, Ica1, Ica2, Ida1, Ida2, Idb1, Idb2, Idc1, Ie1, If1, If2, wherein in each case one of the groups “-alkyl” or “—CN” is replaced by -Sp—P, wherein Sp and P have the same or different meanings compared to the existing group -Sp—P.

Especially preferred compounds with two polymerizable groups are selected from the following group of formulae 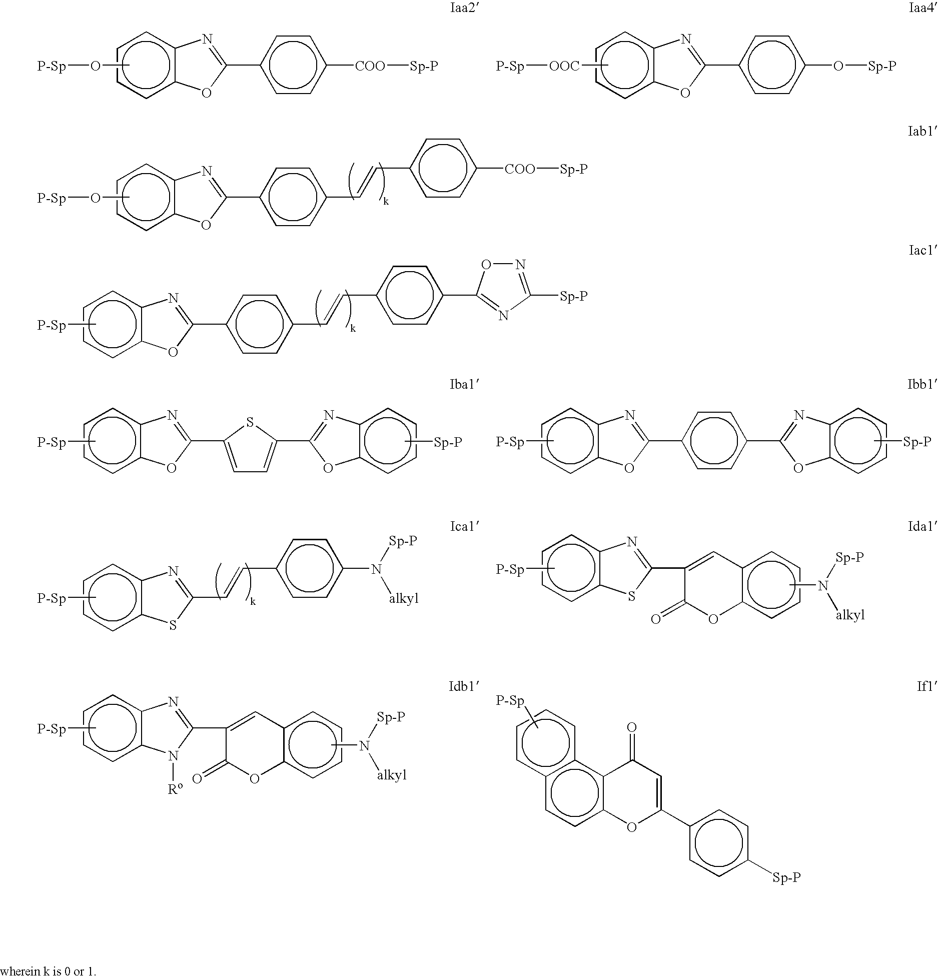
wherein k is 0 or 1.

The polymerizable mixture according to the invention comprises at least one polymerizable, luminescent inventive compound. Preferably it comprises one compound of formula I, but it may also comprise 2, 3 or more compounds of formula I. Preferably the mixture comprises further components as described below, but the mixture may also consist of 1, 2, 3 or more compounds of formula I only. Additionally the inventive mixture may contain other luminescent compounds, which may be polymerizable or not. Advantageously the luminescent compounds are selected according to their emission wavelengths in such a way that their combination yields the desired luminescent color.

Furthermore one or more first luminescent compounds may be combined with one or more second luminescent compounds such that the emission wavelengths of the first compounds lie within the absorption region, preferably the maximum absorption, of the latter compounds. Thus excitation at the absorption wavelength of the first compounds yields emitted light of the emission wavelengths of the second compounds.

Preferably the inventive mixture further comprises at least one polymerizable mesogenic compound of formula II
P [symbol] Sp-X [symbol] ₙMG-R²¹ II
wherein
P is a polymerizable group,
Sp is a-spacer group having 1 to 20 C-atoms,
X is a group selected from —O—, —S—, —CO—, —COO—, —OCO—, —O—COO—, —SO₂—O—, —O—SO₂— or a single bond,
n is 0 or 1,
R²¹ is H or an alkyl radical with up to 25 C atoms which may be unsubstituted, mono- or polysubstituted by halogen or CN, it being also possible for one or more non-adjacent CH₂ groups to be replaced, in each case independently from one another, by —O—, —S—, —NH—, —N(CH₃)—, —CO—, —COO—, —OCO—, —OCO—O—, —S—CO—, —CO—S— or —C≡C— in such a manner that oxygen atoms are not linked directly to one another, or alternatively R²¹ is halogen, cyano or has independently one of the meanings given for P—(Sp—X)ₙ—,
MG is a mesogenic or mesogenity supporting group.

The mixture according to this particularly preferred embodiment preferably comprises one to six, most preferably two to four different mesogens according to formula II having one or two, preferably one, polymerizable functional groups.

The mesogenic or mesogenity supporting group MG in formula II is preferably selected of formula III: [symbol]
A³¹-Z³¹ [symbol] ₘA³²-Z³²A³³- III
wherein
A³¹, A³²,
A³³ being independently from one another 1,4-phenylene in which, in addition, one or more CH groups may be replaced by N, 1,4-cyclohexylene in which, in addition, one or two non-adjacent CH₂ groups may be replaced by O and/or S, 1,4-cyclohexenylene or naphthalene-2,6-diyl, it being possible for all these groups to be unsubstituted, mono- or polysubstituted with halogen, cyano or nitro groups or alkyl, alkoxy or alkanoyl groups having 1 to 7 C atoms wherein one or more H atoms may be substituted by F or Cl,
Z31, Z³² being independently from one another —O—, —CO—, —COO—, —OCO—, —O—SO₂—, —SO₂—O—, —CH₂CH₂—, —OCH₂—, —CH₂O—, —CH═CH—, —C≡C—, —CH═CH—COO—, —OCO—CH═CH— or a single bond and
m being 0, 1 or 2.

Bicyclic and tricyclic mesogenic groups are preferred.

Of the compounds of formula II especially preferred are those in which R²¹ is F, Cl, cyano, or optionally halogenated alkyl or alkoxy, or has the meaning given for P—(Sp—X)ₙ—, and MG is of formula III wherein Z³¹ and Z³² are —COO—, —OCO—, —CH₂—CH₂—, —CH═CH—COO—, —OCO—CH═CH— or a single bond.

A smaller group of preferred mesogenic groups MG of formula III is listed below. For reasons of simplicity, Phe in these groups is 1,4-phenylene, PheL is a 1,4-phenylene group which is substituted by at least one group L, with L being F, Cl, CN, NO₂ or an optionally fluorinated alkyl, alkoxy or alkanoyl group with 1 to 4 C atoms, and Cyc is 1,4-cyclohexylene.
-Phe-Z³²-Phe- III-1
-Phe-Z³²-Cyc- III-2
-PheL-Z³²-Phe- III-3
-PheL-Z³²-Cyc- III-4
-Phe-Z³²-PheL- III-5
-Phe-Z³′-Phe-Z3²-Phe- III-6
-Phe-Z³¹-Phe-Z³²-Cyc- III-7
-Phe-Z³¹-Phe-Z³²-PheL- III-8
-Phe-Z³′-PheL-Z³²-PheL- III-9
-Phe-Z³¹-Cyc-Z³²-Phe- III-10
-Phe-Z³¹ -Cyc-Z³²-Cyc- III-11
-Phe-Z³′-PheL-Z³²-Phe- III-12
-PheL-Z³f-Phe-3²-Phe- III-13
-PheL-Z³¹-Phe-Z³²-PheL- III-14
-PheL-Z3¹-PheL-Z3²-Phe- III-15
-PheL-Z³f-PheL-Z³²-PheL- III-16

In these preferred groups Z³¹ and Z³² have the meaning given in formula III described above. Preferably Z31 and Z³² are —O—, —COO—, —OCO—, —CO—, —O—SO₂—, —SO₂—O—, —CH₂CH₂—, —CH═CH— or a single bond.

PheL in these preferred formulae is very preferably denoting 1,4-phenylene which is monosubstituted with L in the 2- or 3-position or disubstituted with L in the 2- and 3-position or in the 3- and 5-position, with L having each independently one of the meanings given above.

L is preferably F, Cl, CN, NO₂, CH₃, C₂H₅, OCH₃, OC₂H₅, COCH₃, COC₂H₅, CF₃, OCF₃, OCHF₂, OC₂F₅, in particular F, Cl, CN, CH₃, C₂H₅, OCH₃, COCH₃ and OCF₃, most preferably F, CH₃, OCH₃ and COCH₃.

MG in formula III particularly preferably has one of the following meanings 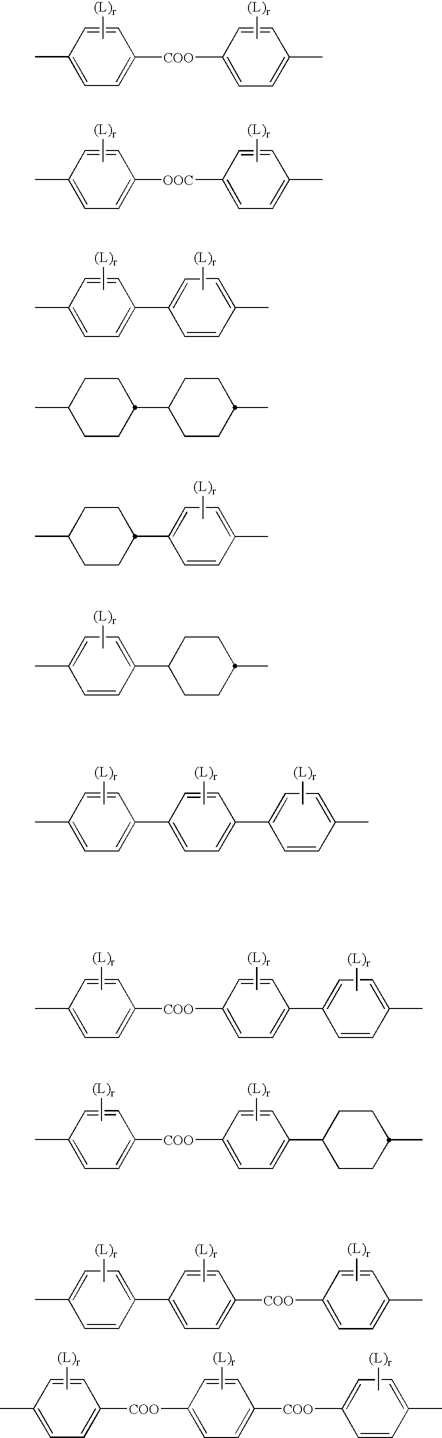 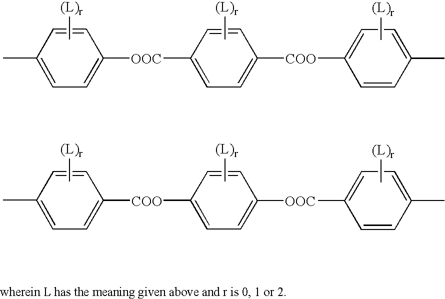
wherein L has the meaning given above and r is 0, 1 or 2.

The group 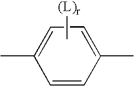
in this preferred formulae is very preferably denoting 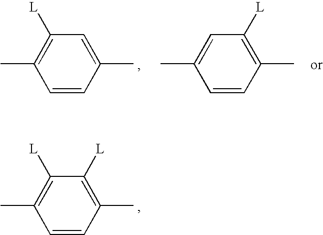
furthermore 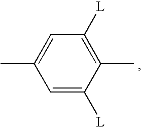
with L having each independently one of the meanings given above, preferably —F.

R²¹ in these preferred compounds is particularly preferably CN, F, Cl, OCF₃, or an alkyl or alkoxy group with 1 to 12 C atoms or has one of the meanings given for P—(Sp—X)ₙ-.

Typical examples representing polymerizable mesogenic compounds of the formula II can be found in WO 93/22397; EP 0 261 712; DE 195 04 224; DE 44 08 171 and DE 44 05 316. The compounds disclosed in these documents, however are to be regarded merely as examples that should not limit the scope of this invention.

Furthermore, typical examples representing polymerizable mesogenic compounds like those of formula II are shown in the following list of compounds, which is, however, to be understood only as illustrative without limiting the scope of the present invention:

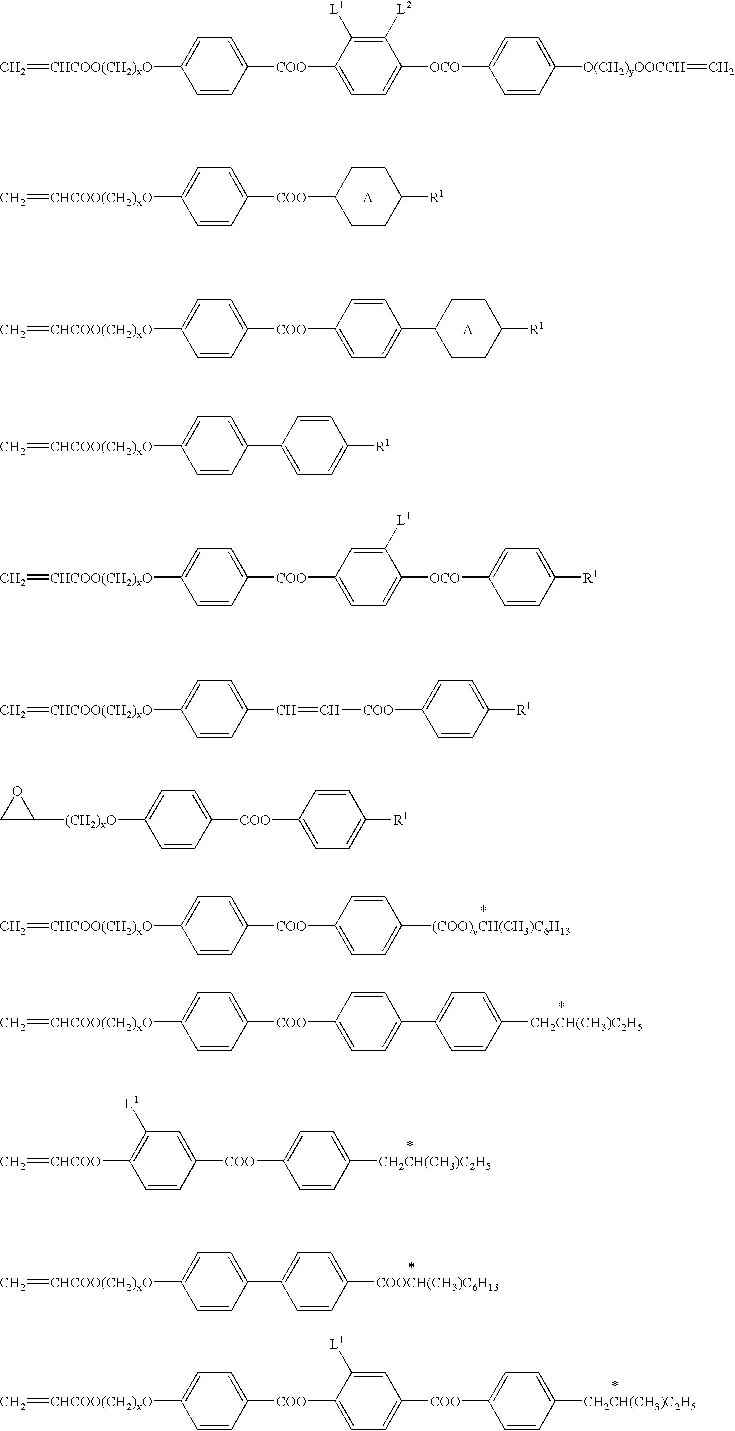

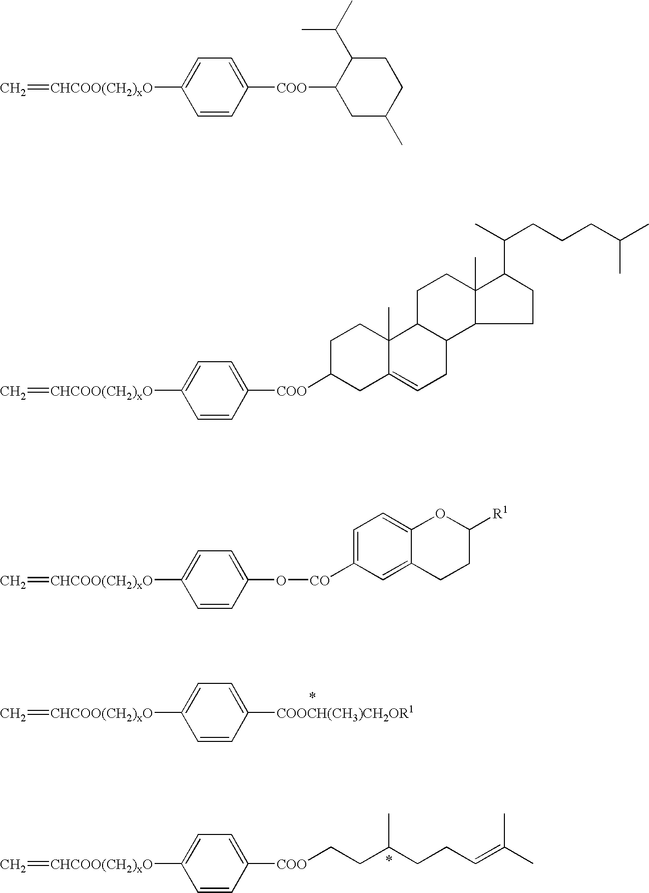

In these compounds x and y are each independently 1 to 12, v is 0 or 1, A is a 1,4phenylene or 1,4-cyclohexylene group, R¹ is halogen, cyano or an optionally halogenated alkyl or alkoxy group with 1 to 12 C atoms and L¹ and L² are each independently H, F, Cl, CN or an optionally halogenated alkyl, alkoxy or alkanoyl group with 1 to 7 C atoms.

In a preferred embodiment the polymerizable mixture according to the invention further comprises at least one polymerizable and photoorientable compound. Photoorientable compounds are uniformly orientable by exposure to polarized electromagnetic radiation, especially linearly polarized light. Their orientation induces a co-operative alignment of the side groups and co-components to the same direction and a comparable degree of order. One known process is the photo-induced isomerization, e.g. of azo-groups, cinnamic acid ester groups or cinnamic acid amid groups. Known photoorientable compounds and techniques are described e.g. by M. Schadt (Information Display 12, 1997, 14-18; Journal of the SID 5/4, 1997, 367-370 and literature cited therein) and in WO 00/34808. The orientation of these polymerizable and photoorientable compounds and of the other components of the polymerizable mixture is frozen by a subsequent polymerization and/or cross-linking, which is preferably induced by electromagnetic radiation and may be done simultaneously with the photoorientation process. An annealing of the thus photo-oriented, polymerized and/or cross-linked mixture, preferably above the glass transition temperature, can result in a significant amplification of the photo-induced anisotropy.

Preferred compounds which are polymerizable and photoorientable are denoted by the formula IV
P—(Sp—X)ₙ-A⁴¹-A⁴²-Z⁴-A⁴³-A⁴⁴-R⁴¹ IV
wherein
P, Sp, X and n are defined as above,
R⁴¹ has one of the meanings given for R¹,
A⁴¹, A⁴²,
A⁴³, A⁴⁴ are independently of each other 1,4-phenylene, wherein 1, 2, 3 or 4 H-atoms may be replaced by F or Cl,
A⁴¹, A⁴⁴ may in addition to the above given meaning denote independently of each other a single bond,
Z⁴ is —N═N—, —CH═CH— or —(O)ₛ₁—(CH₂)ₛ₂—O—CO—CH═CH— with s1 being 0 or 1 and s2 being 0 to 6.

Especially preferred compounds of formula IV are selected from the following list of formulae 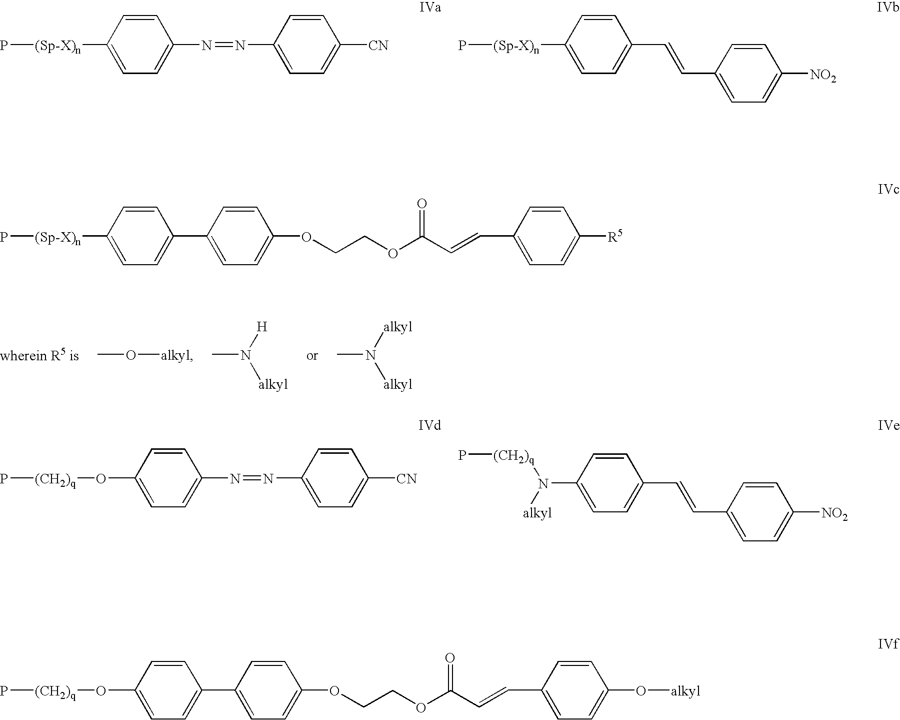
wherein q is 1 to 12.

The polymerizable mixture according to the invention preferably contains at least one photoinitiator, if the polymerization step is to be induced by actinic radiation, especially light in the UV or visible range.

Furthermore if a cross-linked polymer material is desired, the inventive polymerizable mixture may also comprise a non-mesogenic compound having two or more polymerizable functional groups.

The polymerizable mixture according to the invention may additionally contain one or more chiral compounds which comprise a group having at least one center of chirality. Especially suitable are those chiral compounds described in WO 98/42799, especially those of the formula I, wherein MG-R is selected according to formula IIa and IIb as disclosed in WO 98/42799 which is incorporated herein by reference. Particularly preferred compounds are selected of the following formula 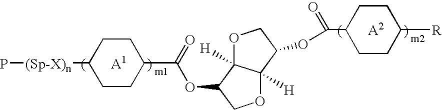
wherein the rings A¹, A² are independently of each other 1,4-phenylene or 1,4cyclohexylene, m1, m2 are independently of each other 1 or 2 and R has one of the meanings of R¹ or denotes —(X-Sp)ₙ—P. Groups, e.g. A¹, A², X, Sp, P, occuring twice may have identical or different meanings.

Furthermore the polymerizable mixture may additionally contain one or more compounds having electron- and/or hole-transport properties. The addition of such compounds is especially useful in the preparation of electroluminescent polymer materials and devices. Besides the function as an emitter, the electroluminescent layer of such devices, e.g. OLEDs or backlights, may also have the function as an electron- and/or hole-transport layer. These electron- and/or hole-transport compounds may be polymerizable or non-polymerizable.

Compounds with electron-transport capabilities are listed below, but are not limited to these examples:
2-(4-(1-Methyl-ethyl)phenyl)-6-phenyl-4H-thiopyran-4-ylidene-propanedinitril-1,1 -dioxide
1,3-Bis(4-(4-diphenylamino)-phenyl-1,3,4-oxadiazol-2-yl)benzene
2-(4-Biphenylyl)-5-(4-tertbutylphenyl)-1,2,3-oxadiazole
2-(4-Methylphenyl)-6-phenyl-4H-thiopyran-4-ylidene]-propanedinitril-1,1-dioxide

Compounds with hole-transport capabilities are listed below, but are not limited to these examples:
4,4′,4″-Tris(carbazol-9-yl)-triphenylamine
1,3-Bis(4-(4-diphenylamino)-phenyl-1,3,4-oxadiazol-2-yl)benzene
1,1-Bis-(4-bis(4-methyl-phenyl)-amino-phenyl)-cyclohexane
N,N,N′,N′-Tetrakis(4-methylphenyl)-benzidine
N,N,N′,N′-Tetrakis(3-methylphenyl)-benzidine
4,4′-Bis(dibenz-azepin-1-yl)-biphenyl
N,N′-Bis-(3-methylphenyl)-N,N′-bis-(phenyl)-benzidine
N,N,N′,N′-Tetraphenylbenzidine
N,N′-Bis-(4-methylphenyl)-N,N′-bis-(phenyl)-benzidine
4,4′-Bis(carbazol-9-yl)-biphenyl
N,N′-Di-(4-methyl-phenyl)-N,N′-diphenyl-1,4-phenylendiamine
4-(2,2-Bisphenyl-ethen-1-yl)-triphenylamine
N-(Biphenyl4-yl)-N,N-bis(3,4-dimethyl-phenyl)-amine
N-Biphenylyl-N-phenyl-N-(3-methylphenyl)-amine
4,4′,4″-Trismethyl-triphenylamine

In the following, preferred meanings of groups and substituents are described.

P is preferably selected from the following groups 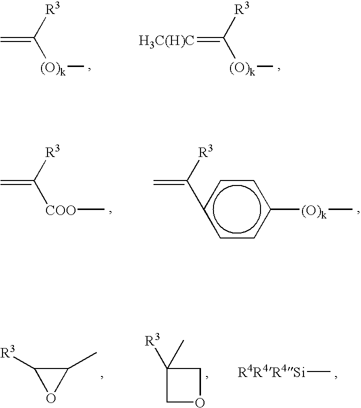
wherein
R³ is H, Cl or alkyl with 1 to 5 C-atoms, preferably methyl, ethyl or n-propyl,
R⁴, R⁴′, R⁴″ are independently of each other —Cl, —O-alkyl and/or —O—CO-alkyl with alkyl having 1 to 5 C-atoms and
k is 0 or 1.

P is particularly preferably a vinyl group, an acrylate group, a methacrylate group, a propenyl ether group or an epoxy group, very particularly preferably an acrylate or methacrylate group.

A preferred meaning of R¹, R², R²¹ and/or R⁴¹ is alkyl, alkoxy and oxaalkyl.

An alkyl-radical may be straight-chain, branched or cyclic. It is preferably straight-chain, has 2, 3, 4, 5, 6, 7 or 8 carbon atoms and accordingly is preferably ethyl, propyl, butyl, pentyl, hexyl, heptyl or octyl, furthermore methyl, nonyl, decyl, undecyl, dodecyl, tridecyl, tetradecyl or pentadecyl, for example.

An alkoxy-radical, i.e. where the terrninal CH₂ group is replaced by —O—, may be straight-chain, branched or cyclic. It is preferably straight-chain, has 2, 3, 4, 5, 6, 7 or 8 carbon atoms and accordingly is preferably ethoxy, propoxy, butoxy, pentoxy, hexoxy, heptoxy or octoxy, furthermore methoxy, nonoxy, decoxy, undecoxy, dodecoxy, tridecoxy or tetradecoxy, for example.

A preferred oxaalkyl-radical, i.e. where one CH₂ group is replaced by —O—, is preferably straight-chain 2-oxapropyl (═methoxymethyl), 2-(═ethoxymethyl) or 3-oxabutyl (═2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl or 2-, 3-, 4-, 5-, 6-, 7-, 8- or 9-oxadecyl, for example.

In the compounds of formula I, II and IV R¹, R², R²¹ and/or R⁴¹ may be an achiral or a chiral group.

Preferred chiral groups are 2-butyl (═1-methylpropyl), 2-methylbutyl, 2-methylpentyl, 3-methylpentyl, 2-ethylhexyl, 2-propylpentyl, 2-octyl, in particular 2-methylbutyl, 2-methylbutoxy, 2-methylpentoxy, 3-methylpentoxy, 2-ethylhexoxy, 1-methylhexoxy, 2-octyloxy, 2-oxa-3-methylbutyl, 3-oxa-4-methylpentyl, 4-methylhexyl, 2-nonyl, 2-decyl, 2-dodecyl, 6-methoxyoctoxy, 6-methyloctoxy, 6-methyloctanoyloxy, 5-methylheptyloxycarbonyl, 2-methylbutyryloxy, 3-methylvaleryloxy, 4-methylhexanoyloxy, 2-chlorpropionyloxy, 2-chloro-3-methylbutyryloxy, 2-chloro-4-methylvaleryloxy, 2-chloro-3-methylvaleryloxy, 2-methyl-3-oxapentyl, 2-methyl-3-oxahexyl, 1-methoxypropyl-2-oxy, 1-ethoxypropyl-2-oxy, 1-propoxypropyl-2-oxy, 1-butoxypropyl-2-oxy, 2-fluorooctyloxy, 2-fluorodecyloxy, for example.

In addition, mesogenic compounds of the formula I, II and IV containing an achiral branched group R¹, R², R²¹ and/or R⁴¹ can be of importance as comonomers, for example, as they reduce the tendency towards crystallization. Branched groups of this type generally do not contain more than one chain branch. Preferred branched groups are isopropyl, isobutyl (═methylpropyl), isopentyl (═3-methylbutyl), isopropoxy, 2-methylpropoxy and 3-methylbutoxy.

As for the spacer group Sp in formula I, II and IV all groups can be used that are known for this purpose to the skilled in the art. The spacer group Sp is preferably linked to the polymerizable group P by an ester or ether group or a single bond. The spacer group Sp is preferably a linear or branched alkylene group having 1 to 20 C atoms, in particular 1 to 12 C atoms, in which, in addition, one or more non-adjacent CH₂ groups may be replaced by —O—, —S—, —NH—, —N(CH₃)—, —CO—, —O—CO—, —CO—O—, —O—CO—O—, —SO₂O—, —O—SO₂—, —CH(halogen)-, —CH(CN)—, —CH═CH— or —C═C—.

Typical spacer groups Sp are for example —(CH₂)ₒ—, —(CH₂CH₂O)ᵣ—CH₂CH₂—, —CH₂CH₂—S—CH₂CH₂— or —CH₂CH₂—NH—CH₂CH₂—, with o being an integer from 2 to 12 and r being an integer from 1 to 3.

Preferred spacer groups Sp are ethylene, propylene, butylene, pentylene, hexylene, heptylene, octylene, nonylene, decylene, undecylene, dodecylene, octadecylene, ethyleneoxyethylene, methyleneoxybutylene, ethylene-thioethylene, ethylene-N-methyl-iminoethylene and 1-methylalkylene, for example.

In one embodiment of the invention the polymerizable compounds of formula I, II andlor IV comprise a spacer group Sp that is a chiral group of the formula V: 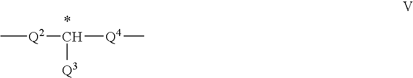
wherein
Q² is an alkylene or alkylene-oxy group with 1 to 10 C atoms or a single bond,
Q³ is halogen, a cyano group or an alkyl or alkoxy group with 1 to 4 C atoms,
Q⁴ is an alkylene or alkylene-oxy group with 1 to 10 C atoms or a single bond, being different from Q².

In particular preferred are compounds of formula I, II and IV wherein n is 1.

In the event that the compounds of formula I, II and/or IV contain a group, like P—Sp—X— or alkyl, twice or more times these groups may be identical or different.

The polymerizable compounds of formula I and II as disclosed in the foregoing and the following can be prepared by methods which are known per se and which are described in the documents cited above and, for example, in standard works of organic chemistry such as, for example, Houben-Weyl, Methoden der organischen Chemie, Thieme-Verlag, Stuttgart. Further methods of preparation can be taken from the examples.

The luminescent polymer material according to the invention is obtainable by polymerizing an inventive polymerizable mixture.

Two different types of luminescent polymer materials may be distinguished. In the first kind of luminescent polymer materials the luminescent chromophor units, also denoted as lumophor units or fluorophor units in the case of fluorescence, are just contained in a polymer matrix serving as a host, with no chemical bonds formed between the lumophor units and the polymer chains. The second kind of luminescent polymer materials shows lumophor units being chemically bound to the polymer chains. Here the lumophor units are part of the main chains and/or the side chains. Luminescent polymer materials according to this invention are preferably such of the second kind. In addition to the lumophor unit or units being part of the main chain and/or side chains, it is possible that further lumophor units are just contained in the polymer matrix without any chemical bonds to the polymer chains.

Preferably such a material is obtainable by a process comprising the following steps:
a) forming a thin layer of the polymerizable mixture,
b) aligning the molecules of the compounds of the mixture in the thin layer into a uniform orientation or a patterned orientation such that in each pattern the orientation is uniform,
c) polymerizing said polymerizable material.

Especially suitable for this process are polymerizable mixtures comprising at least one polymerizable mesogenic compound according to the invention.

Preferably the step a) is performed by coating a thin layer of the polymerizable mixture onto a carrier material or onto a substrate or between two substrates. The thin film has preferably a thickness in the range of 1 μm to 5 mm, especially 1 μm to 1 mm, most preferably in the range of 2 μm to 500 μm. If one or two substrates are used, after the polymerizing step c) one or both substrates are removed preferably. Advantageously the carrier material and/or the substrate are transparent, at least in the wavelength range of the excitation and/or emission of the luminescent polymer material. By this procedure a luminescent polymer film of the above thickness is obtained, which may be structured or unstructured. The structuring may be achieved by applying the luminescent polymer material on a patterned substrate or the material or the film is patterned by known techniques like lithography.

The orientation is achieved by known orientation techniques, like those mentioned in the introduction. A preferred technique is the photo-orientation, e.g. described by M. Schadt as cited above. If a photo-orientation step is applied, those polymerizable mixtures are preferred comprising at least one polymerizable and photoorientable compound according to the invention. Also the technique described in WO 00/34808 to manufacture layers of cholesterically ordered polymer material is applicable.

The polymerizing step c) is preferably done by exposure of the oriented thin layer to heat or to actinic radiation.

The polymer chains may be in part or totally cross-linked. In the curing process the polymerizable groups of the aligned material react to form a crosslinked polymer film. Thereby the orientation is frozen in. The polymerization can be carried out for example by exposure to UV light with the help of a photoinitiator that decomposes under irradiation to produce free radicals that start the polymerization reaction. In another preferred embodiment a cationic photoinitiator is used that photocures with cations instead of free radicals. The polymerization may also be started by an initiator that decomposes when heated above a certain temperature.

To exclude oxygen that may inhibit the free radical polymerization, a layer, e.g. comprising PET, may be laminated on top of the thin layer, or alternatively the curing can be carried out under a nitrogen atmosphere. When using a cationic photoinitiator oxygen exclusion is not needed, but water should be excluded.

As described above, it may be advantageous to anneal the polymer material, especially above the glass transition temperature of the material, in order to amplify the anisotropy and thus to yield a higher dichroitic ratio. The annealing is preferably performed between one hour and several days, especially 2 hours up to 3 days.

These methods, however are only to be understood as examples that should not limit the scope of the invention. The person skilled in the art can easily find other suitable ways to carry out the polymerization.

Since the mixture may contain both polymerizable components with one (monofunctional) and with two or more polymerizable groups (multifunctional), polymerization and crosslinking are carried out in the same process.

By varying the concentration of the multifunctional mesogenic or non mesogenic components the crosslink density and thereby the product properties, such as the glass transition temperature, the temperature dependence of the optical properties, the thermal and mechanical stability and the solvent resistance can be tuned easily.

The luminescent polymer material according to the invention may be used for the manufacture of pigment flakes. The obtained luminescent polymer film is grinded into small particles of the desired dimensions to obtain luminescent pigment flakes. If according to step a) a carrier material is coated, preferably a platelet shaped carrier material is chosen. As carrier material for example natural or synthetic mica (muscovite or phlogopite), kaoline, talc, silica flakes, glass flakes or mixtures of two or more of these materials can be used. In a preferred embodiment of the present invention mica is used as carrier material. A detailed description of the manufacture of pigment flakes, their characteristics and their use is given in the WO 98/42799 which is incorporated by reference. One or more compounds of formula I according to this invention may be used instead of or in addition to compounds of formula I*, as described in WO 98/42799 and in the prior art section of this application.

The luminescent polymers according to the invention and products made thereof may be used in display devices mentioned in the introduction. Furthermore they may be used in an electrooptic color display e. g. according to U.S. Pat. No. 4,822,144 or WO 00/57239, where a backlight, switching elements and a luminescent pattern are combined.

The complete disclosure of all applications, patents and publications mentioned hereinbefore and hereinafter is introduced into this application by way of reference.

From the foregoing description, one skilled in the art can easily ascertain the essential characteristics of this invention, and without departing from the spirit and scope thereof, can make various changes and modifications of the invention to adapt it to various usages and conditions.

Without further elaboration, it is believed that one skilled in the art can, using the preceding description, utilize the present invention to its fullest extent. The following examples are, therefore, to be construed as merely illustrative and not limitative of the remainder of the disclosure in any way whatsoever.

In the foregoing and in the following examples, unless otherwise indicated, all temperatures are set forth uncorrected in degrees Celsius and all parts and percentages are by weight. The dichroitic ratio R is the ratio Eₚ/Eₛ of the extinction Eₚ, where the wave vector of the incident linearly polarized light is parallel to the direction of the orientation of the molecules, to the extinction Eₛ, where the wave vector of the incident linearly polarized light is perpendicular to the direction of the orientation of the molecules. The dichroitic ratio is a measure of the anisotropy of the polymer material.

### EXAMPLES

The following examples are set forth to further illustrate the present invention and should not be construed as limiting the spirit or scope of the invention.

### Example 1

### Synthesis of 5-(6-methacryloyloxyhexyloxy)-2-(4′-cyanophenyl)benzoxazole

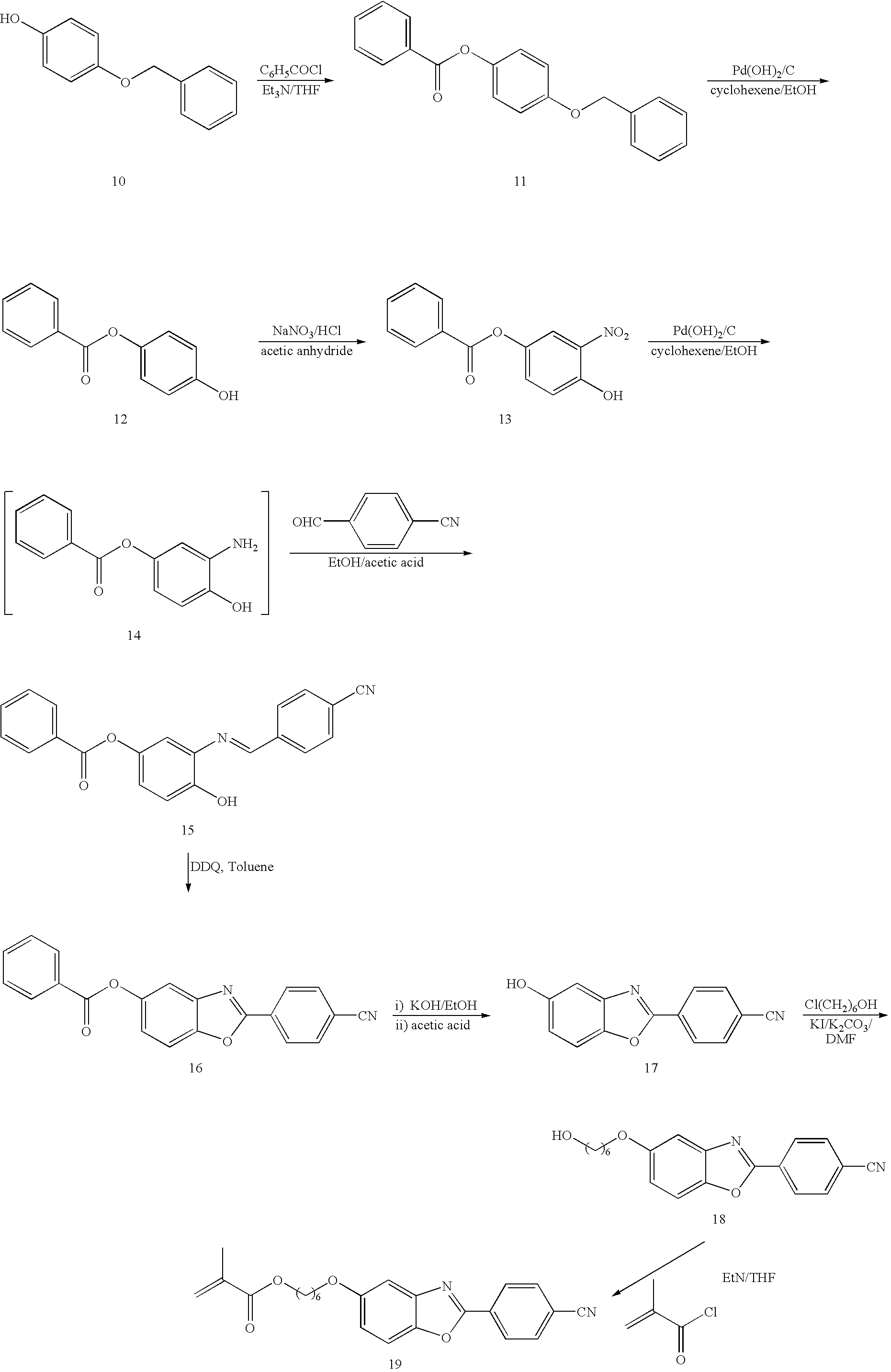 1.1 Synthesis of 4-hydroxy-3-nitrophenyl benzoate 13

7 ml benzoyl chloride were added dropwise to a solution of 4-benzyloxyphenol 10 (0.05 mol) and triethylamine (0.06 mol) in dry tetrahydrofurane at room temperature. The resulting mixture was stirred for 30 min and then the precipitate filtered off. The solution was washed with a saturated Na₂CO₃ solution (2×100 ml) and water (3×100 ml) dried over MgSO₄, and evaporated to dryness to yield 4-benzyloxyphenyl benzoate 11 as a white solid. Pd(OH)₂ on carbon (3.9 g) was gradually added under argon to a boiling mixture of 4-benzyloxyphenyl benzoate 11 (0.04 mol) in absolute ethanol (170 ml) and cyclohexene 85 ml). After 2 h the reaction was cooled down to room temperature, filtered and evaporated under vacuum to give 4-hydroxyphenyl benzoate 12 as a white solid. A solution of 4-hydroxyphenyl benzoate 12 (0.04 mmol) in dichlormethane (94 ml) and diethyl ether (189 ml) was added to a stirred solution of NaNO₃ (0.04 mol) in concentrated HCI (35.4 ml) and H₂O (47 ml) at room temperature. Then, acetic anhydride (0.6 ml) was added and the reaction kept on stirring for 4 h. The organic phase was separated and the aqueous layer extracted with diethyl ether (2×60 ml). The combined organic layers were dried over MgSO₄ and the solvent eliminated under reduced pressure. The resulting solid recrystallized from ethanol to give 4-hydroxy-3-nitrophenyl benzoate 13 as a spongy yellow solid.

1.2 Synthesis of the Intermediate Imine 15

The ortho-nitrophenol 13 was dissolved in absolute ethanol and cyclohexene (about 45 ml per gram of the nitroderivative) with stirring. Once to the boiling temperature, Pd(OH)₂ on carbon (about 30% of nitroderivative weight) was added under argon. After consumption of the starting material (about 4 h), the reaction was cooled down to room temperature and filtered. The solvent was removed under vacuum to give the ortho-aminophenol 14 as an oil. This oil, without further purification, was dissolved in absolute ethanol and added under argon to a solution of the appropriate 4-substituted benzaldehyde in absolute ethanol. The mixture was heated to reflux temperature with acetic acid (catalytic amount) and stirred for 12 h. The resulting solution was then concentrated and recrystallized from absolute ethanol giving the corresponding imine 15.

1.3 Synthesis of 5-benzoyloxy-2-(4′-cyanophenyl)benzoxazole 16

2,3-dichloro-5,6-dicyano-1,4-benzoquinone (DDQ) (12.00 mmol) was added gradually to a solution of the imine 15 (6.00 mmol) in toluene (200 ml) heated to reflux temperature. After 2 h, the reaction was cooled to room temperature and a saturated NaHCO₃ solution (200 ml) was added. The mixture was extracted with dichloromethane (4×100 ml) and the combined organic layers washed with water (4×100 ml) and dried over MgSO₄. After concentrating the solution under vacuum, the compound was purified on silica gel.

1.4 Synthesis of 2-(4′-cyanophenyl)-5-hydroxybenzoxazole 17

A solution of KOH (200 mg in 5 ml of water) was added dropwise to a solution of 5-benzoyloxy-2-(4′-cyanophenyl)benzoxazole 16 (3.67 mmol) in tetrahydrofurane (100 ml) and 96% ethanol (25 ml) at room temperature. After stirring for 2 h, a large volume of water was added and the resulting mixture was neutralized with acetic acid. Tetrahydrofurane was removed under reduced pressure in order to precipitate 2-(4′-cyano)phenyl-5-hydroxybenzoxazole 17.

1.5 Synthesis of 2-(4′-cyanophenyl)-5-(6-hydroxyhexyloxy) benzoxazole 18

A mixture of 2-(4′-cyanophenyl)-5-hydroxybenzoxazole 17 (3.2 mmol), 6-chloro-1-hexanol (3.52 mmol), K₂CO₃ (4.8 mmol) and Kl (0.64 mmol) in DMF (100 ml) was maintained at reflux temperature for 4 h. Once to room temperature, water was added and the reaction mixture extracted with hexane/ethyl acetate (1:2). The combined organic extracts were washed with water, dried, evaporated and recrystallized.

1.6 Synthesis of 5-(6-methacryloyloxyhexyloxy)-2-(4′-cyanophenyl) benzoxazole 19

Methacryloyl chloride (2.2 mmol) was added to a solution of 2-(4′-cyanophenyl)-5-(6-hydroxyhexyloxy)benzoxazole 18 (1.49 mmol), triethylamine (2.96 mmol) and 2,6-di-tert-butyl-4-methylphenol (3 mg) in THF (50 ml) at 50° C. under argon. After 24 h, 10% NH₄Cl aqueous solution (50 ml) was added. The mixture extracted with DCM and the combined organic extracts washed with water, dried, evaporated and recrystallized (melting point=89° C.).

A solution of the product 19 in THF shows:

λₘₐₓ=336 nm (excitation), λ_{fl}=442 nm (fluorescence).

### Example 2

### Synthesis of 2-(4′-cyanophenyl)-5-hexyloxybenzofurane

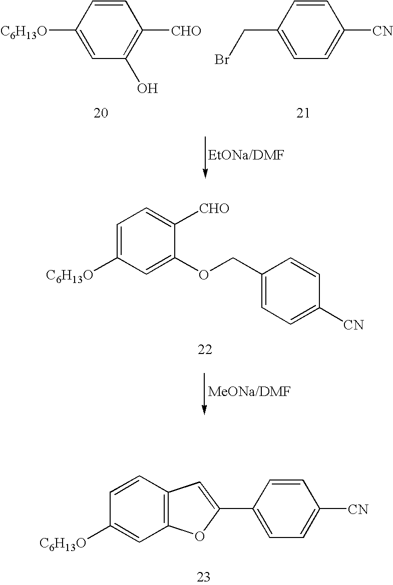

A solution of 4-hexyloxy-2-hydroxybenzaldehyde 20 (13.5 mmol) in dry DMF (12 ml) was added to a solution of sodium (15 mmol) in absolute ethanol (9.5 ml). After stirring for 20 min, 4-cyanobenzyl bromide 21 (15 mmol) in dry DMF (10 ml) was added and the mixture heated to reflux for 4 h. Ethanol was eliminated under reduced pressure and the resulting solution poured into ice/water (60 g) and methanol (20 ml). The resulting white precipitate was isolated by filtration, thoroughly washed with water and dried. The solid was identified as 2-(4′-cyanobenzoyloxy)-4-hexyloxybenzaldehyde (7.85 g, 86%). A solution of 2-(4′-cyanobenzoyloxy)-4-hexyloxybenzaldehyde 22 (4.45 mmol) in dry DMF (10 ml) was added to a solution of sodium (4.6 mmol) in methanol (2 ml). The mixture was stirred at reflux temperature of 1 h. After cooling to room temperature, methanol was added (20 ml). The crude white precipitate was filtered and purified by flash column chromatography on silica gel using hexane/ethyl acetate (9:1) as eluant to yield the required 2-(4′-cyanophenyl)-5-hexyloxy-benzofurane 23.

A solution of the product 23 in THF showed absorption bands at 208 nm and 344 nm and fluorescence at 409 nm.

The product 23 may be transformed into a polymerizable compound by methods known to the one skilled in the art, e.g. by cleavage of the hexylether and synthesis steps in analogy to the examples 1.5 and 1.6.

### Example 3

### Synthesis of the Benzoxazole Derivative 34

Starting from 2-Amino-1-hydroxy-4-methylbenzene 30, the benzoxazole derivative 34 is synthesized in an analogous manner to the reaction steps 1.2 to 1.6 (compounds 14 to 19) in example 1 above.

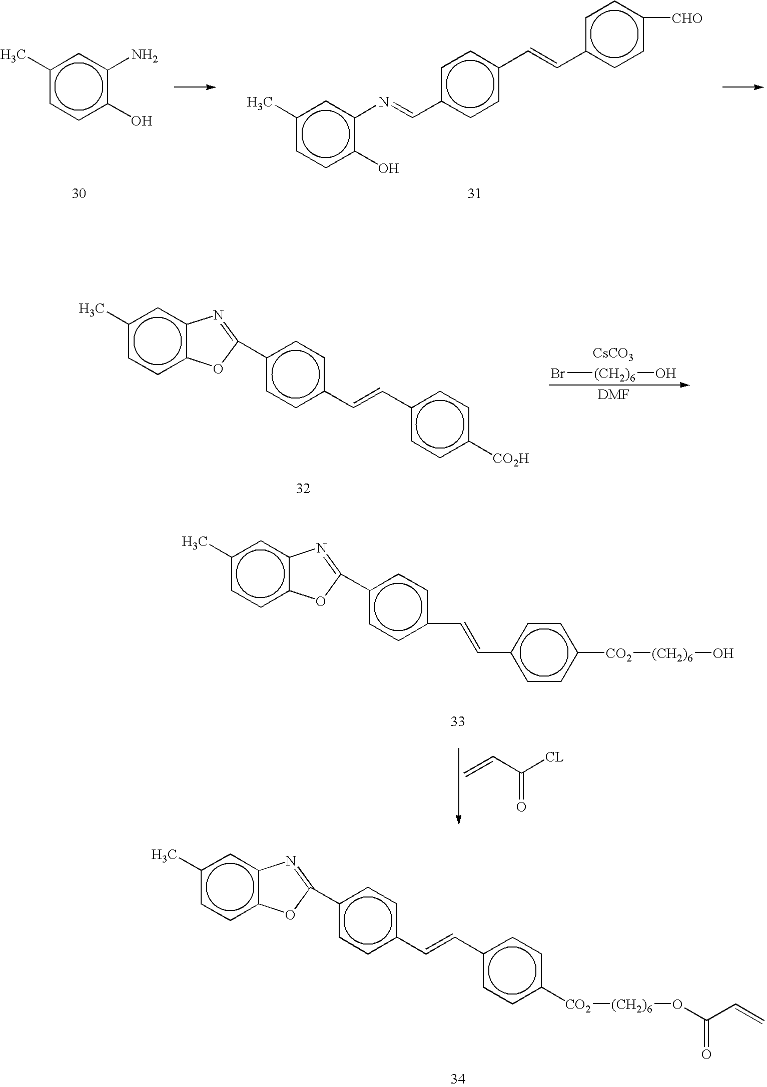

A solution of the product 34 in the mixture M2, as defined below, shows an absorption band at 370 nm and an emission band at 445 nm with a dichroitic ratio R=12.

### Example 4

### Synthesis of the Benzoxazole Diacrylate 41

Starting from the benzoxazole compound 40, which can be synthesized in analogy to examples 1 and 3, the benzoxazole diacrylate 41 is obtained according to the following scheme:

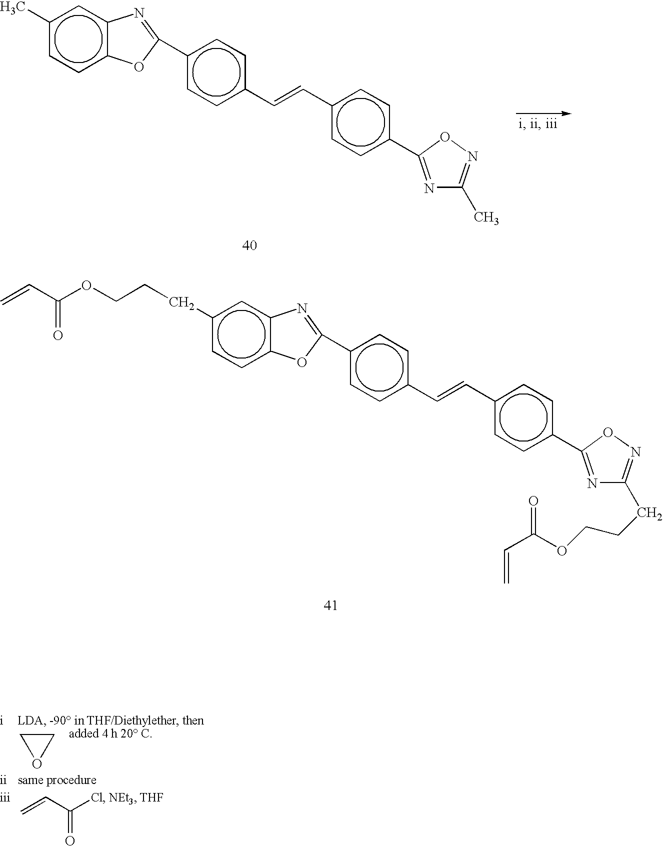

### Example 5

### Synthesis of 5-Glycidyloxy-2-(-4′-cyanophenyl)-benzoxazole 52

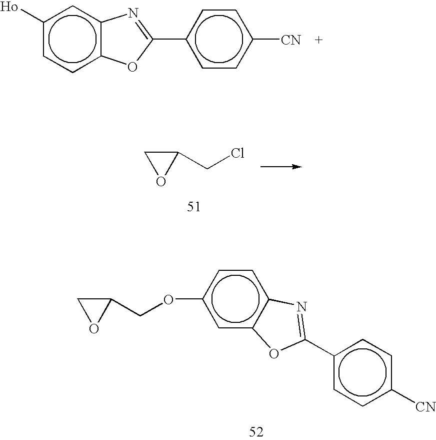

0.05 mol of the benzoxazole 17 (synthesis given in example 1) and 0.05 mol of epichlorhydrin 51 were added to a suspension of powdered KOH (0.1 mol) in 50 ml of tetrahydrofurane. After 16 hours of stirring at room temperature (20° C.) and heating 4 hours to reflux the reaction mixture was poured into water. After separation of the organic phase and extraction of the water phase with ethylacetate the combined organic layers were dried and evaporated to yield 52.

A solution of the product 52 in the mixture M1, as defined below, shows an absorption band at 341 nm and an emission band an 449 nm with a dichroitic ratio R=3.

### Example 6

### Synthesis of A Copolymer

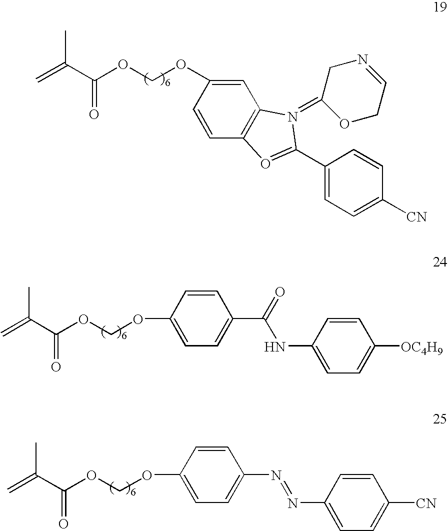

A mixture consisting of 70 weight-% of the liquid crystal matrix forming monomer 24 (R. Ruhmann et al., Acta. Polymer, 41, 1990, 492-497); 15 weight-% of the photo-orientable monomer 25 (S. Czapla et al., Makromol Chem., 194, 1993, 243-250) and 15 weight-% of the luminescent monomer 19 (synthesized as above) was prepared by dissolving them under argon in freshly distilled DMF or THF (approximately 10 weight-%).

The solution was degassed by several vacuum/argon cycles and heated to 70° C. Then, AIBN (azo-bis-isobutyronitrile) (1-5% weight ratio) was added and the solution stirred for at least 48 h. The polymer was precipitated by pouring the reaction mixture over cold 96% ethanol or ether and filtered. Purification was carried out either by dissolving the polymer (in DCM or chloroform) and precipitating it (in ethanol, methanol or diethyl ether) or by extraction in a Soxhlet apparatus. The final polymer was dried under vacuum at 40° C. for 24 h.

The resulting copolymer (molecular weight approx. 6000) showed two absorption bands at 283 nm and 350 nm and a blue fluorescence (λ_{fl}=438 nm at λₑₓₑ=335 nm). The emission spectra were recorded of an approx. 10⁻⁶ M solution in THF by excitation at the maximum absorbance.

A smectic A phase was observed (T_{g}=39° C., Tᵢ=107° C., wherein T denotes the transition temperature from the glass (g) to a mesophase and from a meso to the isotropic (i) phase).

Furthermore a spin-coated film (2000 rpm, 30 sec) was prepared from a THF solution of the copolymer (0.15 mmol). The film was stored for at least one day. The irradiation was carried out using polarized light of an Ar laser at 365 nm (43 mW/cm²). The time of exposure was 5 min. After the irradiation procedure the film was annealed at 90° C. in the liquid crystalline state for 3 days. The copolymer film showed a dichroitic ratio R of 2.5 at 366 nm.

### Example 7

### Composition of the Liquid Crystalline Medium M1

The mixture M1 consists of the following components:

| | |
|---|---|
| PCH-3 | 12% weight |
| PCH-5 | 18% weight |
| PCH-7 | 12.5% weight |
| BCH-5 | 7.5% weight |
| GB-15 | 50% weight |

wherein the acronyms have the following meaning 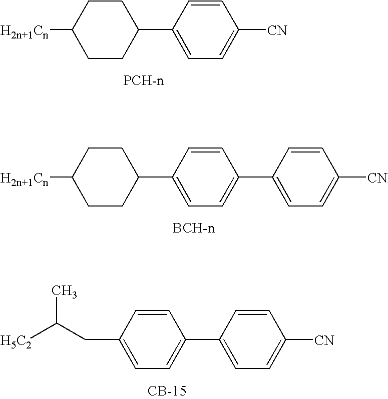
wherein n is 3, 5 or 7.

The product of example 1, 2, 3, 4 and 5 is in each case added to the mixture which is then introduced in a 10 μm cell with alignment layers of rubbed polyimide. The extinction values Eₚ and Eₛ are measured at the given wavelength and the dichroitic ratio R is calculated.

### Example 8

### Composition of the Liquid Crystalline Medium M2

The liquid crystalline and polymerizable mixture M2 consists of the following components (percentages are by weight):

| | |
|---|---|
| 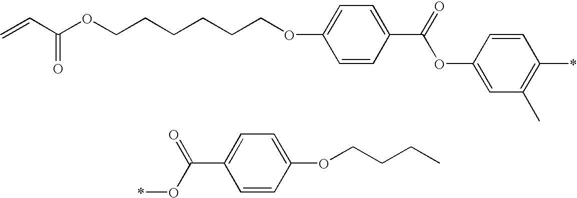 | 3.4% |
| 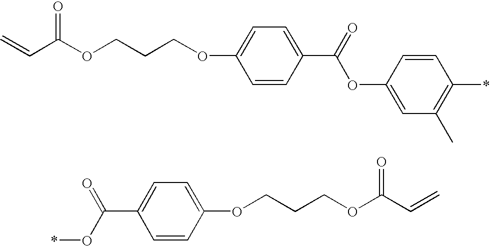 | 22.6% |
| 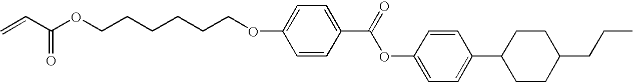 | 40.8% |
| 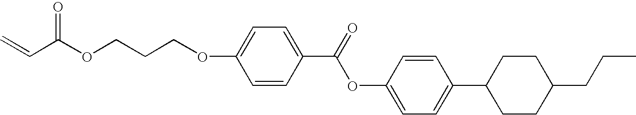 | 29.2% |
| 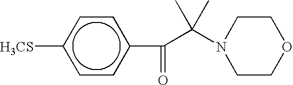 | 4.0% |
| 2,6-Di-tert-butyl-4-methylphenol | 400 ppm |

The product of example 1, 2, 3, 4 and 5 is in each case added to the mixture which is then introduced in a 10 μm cell with alignment layers of rubbed polyimide. The extinction values Eₚ and Eₛ are measured at the given wavelength and the dichroitic ratio R is calculated.

15 mg of the product of example 4 which has been dissolved in THF was mixed with 1 g of liquid crystalline medium M2. From this mixture a layer was prepared via spin-coating. As substrate, glass was used coated with polyimide. After the preparation of the layer, it was tempered for 10 minutes at 40° C. and subsequent cross-linked with 10 mW/cm² at 361 nm. To increase the degree of cross-linking, the layer was tempered again for 10 minutes at 40° C. The resulting layer showed a dichroitic ratio R of 15.0.

1. Polymerizable, luminescent compounds of formula I 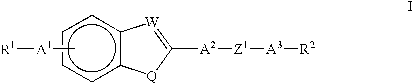
wherein
R¹, R² are independently of each other H, halogen, NO₂, CN, NCS, straight chain, branched or cyclic alkyl with 1 to 25 C-atoms wherein one or more CH₂ groups may also be replaced by —CO—, —O—, —S—, —NR⁰—, —CH═CH—, —C≡C— in such a manner that O- and/or S-atoms are not linked directly to one another, and wherein one or more H-atoms may also be replaced by F or Cl, or denotes P—(Sp—X)ₙ—,
Sp is a spacer group with 1 to 20 C-atoms,
P is a polymerizable group,
X is —O—, —S—, —CO—, —COO—, —OCO—, —CO—NR⁰—, —NR⁰—CO—, —NR⁰— or a single bond,
n is 0 or 1,
R⁰ is H or alkyl with 1 to 5 C-atoms,
A¹ is 1,4-phenylene, wherein 1, 2, 3 or 4 H-atoms may be replaced by F or Cl, or a single bond, 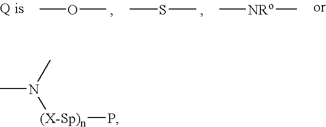
W is —CH═, —N═ or —CO—CH═,
A² is 1,4-phenylene or 2,5-thiophene, wherein in each case one or more H-atoms may be replaced by F or Cl, or denotes a single bond, 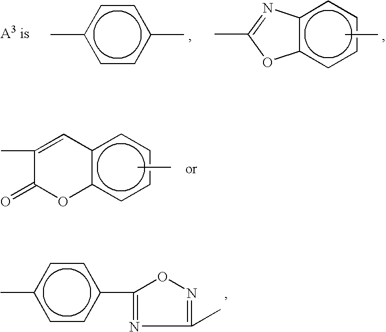
wherein one or more H-atoms can be replaced by F or Cl,
Z¹ is —CH═CH—, —CF═CH—, —CH═CF—, —CF═CF— or a single bond
with the proviso that
a) the compounds of formula I contain one, two or more groups —(X—Sp)ₙ—P,
b) if W denotes —CO—CH═, then 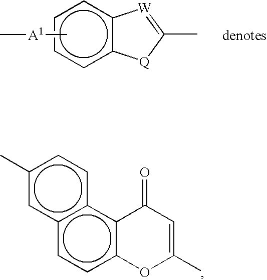
c) if W is —N═, Q is —O—, A² and Z¹ are a single bond, A³ is 1,4-phenylene and R² is P—(Sp—X)ₙ— then R¹ is an achiral group,
d) if W is —N═, Q is —O—, A² and A³ denote 1,4-phenylene and Z¹ is a single bond then A¹ is a single bond.

2. Compounds according to claim 1 wherein W denotes —N═.

3. Compounds according to claim 1 wherin W denotes —CH═ and Q is —O—.

4. Compounds according to claim 2 selected of the following subformulae 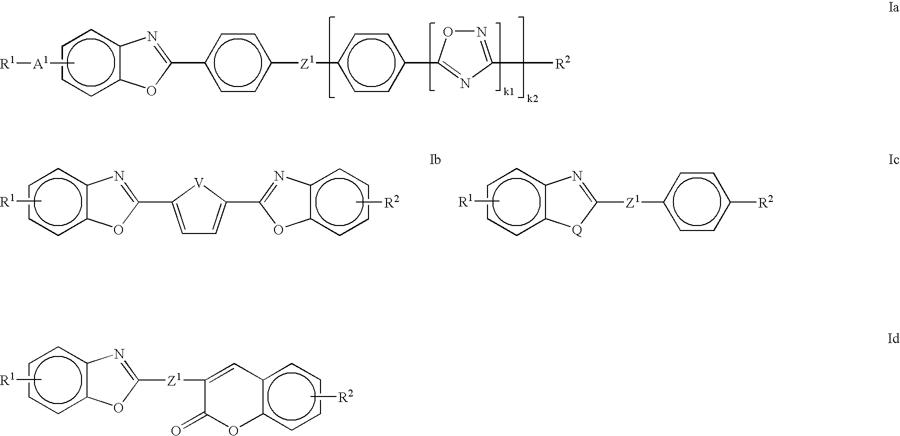
wherein
k1, k2 are independently of each other 0 or 1,
V is —S— or —CH═CH— and
R¹, R², Q,
Z¹ and A¹ are defined as in claim 1,
with the proviso that if Z¹ denotes a single bond, k1=0 and k2=1, then A¹ is a single bond.

5. Compounds according to claim 3 of the subformula Ie 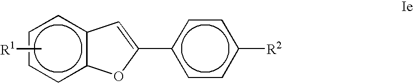
wherein R¹ and R² are defined as in claim 1.

6. Compounds according to claim 1 of the subformula If 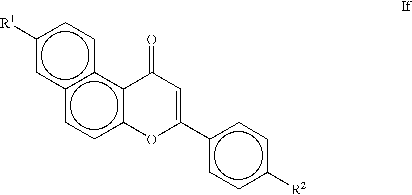
wherein R¹ and R² are defined as in claim 1.

7. Compounds according to claim 1 wherein P is selected from 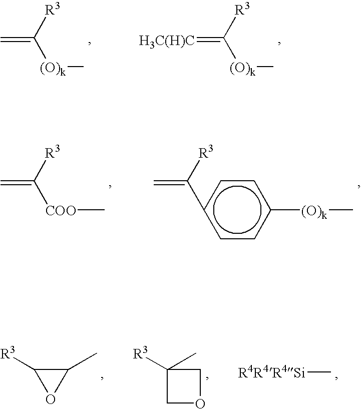
wherein
R³ is H, Cl or alkyl with 1 to 5 C-atoms,
R⁴ , R⁴′, R⁴″ are independently of each other —Cl, —O-alkyl and/or —O—CO-alkyl with alkyl having 1 to 5 C-atoms and
k is 0 or 1.

8. Polymerizable mixture comprising at least one compound according to claim 1.

9. Polymerizable mixture according to claim 8 further comprising at least one polymerizable mesogenic compound of formula II
P [symbol] Sp-X [symbol] ₙMG-R²¹ II
wherein
P is a polymerizable group,
Sp is a spacer group having 1 to 20 C-atoms,
X is a group selected from —O—, —S—, —CO—, —COO—, —OCO—, —O—COO—, —SO₂—O—, —O—SO₂— or a single bond,
n is 0 or 1,
R²¹ is H or an alkyl radical with up to 25 C atoms which may be unsubstituted, mono- or polysubstituted by halogen or CN, it being also possible for one or more non-adjacent CH₂ groups to be replaced, in each case independently from one another, by —O—, —S—, —NH—, —N(CH₃)—, —CO—, —COO—, —OCO—, —OCO—O—, —S—CO—, —CO—S— or —C≡C— in such a maner that oxygen atoms are not linked directly to one another, or alternatively R²¹ is halogen, cyano or has independently one of the meanings given for P—(Sp—X)ₙ—,
MG is a mesogenic or mesogenity supporting group.

10. Polymerizable mixture according to claim 9 wherein MG is a mesogenic or mesogenity supporting group of formula III [symbol]
A³¹-Z³¹ [symbol] ₘA³²-Z³²A³ - III
wherein
A³¹, A³², A³³ being independently from one another 1,4-phenylene in which, in addition, one or more CH groups may be replaced by N, 1,4-cyclohexylene in which, in addition, one or two non-adjacent CH₂ groups may be replaced by O and/or S, 1,4-cyclohexenylene or naphthalene-2,6-diyl, it being possible for all these groups to be unsubstituted, mono- or polysubstituted with halogen, cyano or nitro groups or alkyl, alkoxy or alkanoyl groups having 1 to 7 C atoms wherein one or more H atoms may be substituted by F or Cl,
Z³¹, Z³² being independently from one another —O—, —CO—, —COO—, —OCO—, —SO₂—O—, —O—SO₂—, —CH₂CH₂—, —OCH₂—, —CH₂O—, —CH═CH—, —C≡C—, —CH═CH—COO—, —OCO—CH═CH— or a single bond and
m is 0, 1 oder 2.

11. Polymerizable mixture according to claim 8, further comprising at least one polymerizable and photoorientable compound.

12. Polymerizable mixture according to claim 11 characterized in that the polymerizable and photoorientable compound is denoted by the formula IV
P—(SP—X)ₙ-A⁴¹-A⁴²-Z⁴-A⁴³-A⁴⁴-R⁴¹ IV
wherein
P is a polymerizable group,
Sp is a spacer group having 1 to 20 C-atoms,
X is a group selected from —O—, —S—, —CO—, —COO—, —OCO—, —O—COO—, —SO₂—O—, —O—SO₂— or a single bond,
n is 0 or 1,
A⁴¹, A⁴²,
A⁴³, A⁴⁴ are independently of each other 1,4-phenylene, wherein 1, 2, 3 or 4 H-atoms may be replaced by F or Cl,
A⁴¹, A⁴⁴ may in addition to the above given meaning denote independently of each other a single bond,
Z⁴ is —N═N—, —CH═CH— or [symbol] O [symbol] _{S1} [symbol] CH₂ [symbol] _{S2}O—CO—CH═CH—
with s1 being 0 or 1 and s2 being 0 to 6,
R⁴¹ is H, halogen, NO₂, CN, SCN, straight chain, branched or cyclic alkyl with 1 to 25 C-atoms wherein one or more CH₂ groups can also be replaced by —O—, —S—, —NR⁰—, —CH═CH—, —C≡C— in such a manner that O- and/or S-atoms are not linked directly to one another, and wherein one or more H-atoms can also be replaced by F or Cl, or denotes P—(Sp—X)ₙ—.

13. Polymer material obtainable by polymerizing a polymerizable mixture according to claim 8.

14. Polymer material according to claim 13 obtainable by a process comprising the following steps
a) forming a thin layer of the polymerizable material,
b) aligning the molecules of the compounds of the mixture in the thin layer into a uniform orientation or a patterned orientation such that in each pattern the orientation is uniform,
c) polymerizing said polymerizable material.

15. Use of a compound according to claim 1 for the manufacture of photoluminescent and/or electroluminescent polymer materials.

16. Use of a polymer material according to claim 13 as a photo- and/or electroluminescent material in a light emitting device, an optical or electrooptical display element.

17. Light emitting device comprising a polymer material according to claim 13 as a photo- and/or electroluminescent material.

18. Optical or electrooptical display element comprising a polymer material according to claim 13 as a photo- and/or electroluminescent material.

19. Use of a polymerizable mixture according to claim 8 for the manufacture of photoluminescent and/or electroluminescent polymer materials.
